(19) United States
(12) Patent Application Publication
(10) Pub. No.: US 2022/0005051 A1
(43) Pub. Date: Jan. 6, 2022

(54) ALARM RESPONSE AUTOMATION IN A SUPPLY CHAIN ENVIRONMENT

(71) Applicant: Vertical Solutions, Inc., Cincinnati, OH (US)

(72) Inventors: David Allen Miller, Celina, OH (US); Kristen Kathleen Brannock, Cincinnati, OH (US); Dominic Adrian Irvin, Crestview, FL (US); Ronald William Wegmann, JR., Cincinnati, OH (US)

(21) Appl. No.: 17/361,948

(22) Filed: Jun. 29, 2021

Related U.S. Application Data
(60) Provisional application No. 63/048,250, filed on Jul. 6, 2020.

(51) Int. Cl. G06Q 30/00; G06F 16/245

(52) U.S. Cl. CPC G06Q 30/012; G06Q 10/10; G06F 16/245

(57) ABSTRACT

Systems, methods, and computer program products for alarm response automation in manufacturing, distribution, and general supply chain environments. Sensors categorized as part of an industrial IoT environment are used to detect asset health, including asset abnormalities and trends. Alarm exceptions generate actionable events, which are used to invoke a multi-tiered, hierarchical application of asset entitlements. This data guidance provides enhanced alarm response automation via intelligent filtration and consolidation by grouping recurrent or related alarms from assets, models, model types, components, customers, and sites into a single actionable event. This actionable event has its own unique categorizations that work in concert. At any point, additional, definable processes may be executed to further refine the data. The resulting layered, asset entitlement approach thereby creates a high level of filtration and intelligence from the IoT-generated data.

### CROSS-REFERENCE TO RELATED APPLICATIONS

This claims the benefit of U.S. Provisional Application Serial No. 63/048,250, filed Jul. 6, 2020, the disclosure of which is incorporated by reference herein in its entirety.

### BACKGROUND

This invention relates to alarm response automation in conjunction with a multi-tiered hierarchical application of asset entitlements.

With the advent of the Internet of Things (IoT), substantial focus has been placed on consolidating, filtering, and contextualizing end-point sensor data. However, whether to process this data at an edge device, in the cloud, or using a combination of edge and cloud processing, has generated unforeseen hurdles. Graphical representations offering more granular trending data of assets has been the primary application of IoT technology. What has been lacking in the supply chain environment is how to use IoT technology to provide a better customer experience.

Many assets include entitlements, such as free or reduced cost repair or replacement of failed or damaged assets. However, tracking and properly requesting delivery of these entitlements when appropriate is a complex time consuming task. This complexity often leads to frustration and loss of entitlements, resulting in customer dissatisfaction.

Thus, there is a need for improved systems, methods, and computer program products that provide improved management of asset entitlements using IoT-based technologies.

### SUMMARY

This invention overcomes the foregoing and other shortcomings and drawbacks of IoT technologies heretofore known for use for automatically applying entitlements to assets. While the invention is discussed in connection with certain embodiments, it should be understood that the invention is not limited to the specific embodiments described herein.

In an embodiment of the invention, an apparatus is provided. The apparatus includes one or more processors, and a memory coupled to the one or more processors including program code. When executed by the one or more processors, the program code causes the apparatus to receive an alarm from an IoT device and determine if the alarm is actionable. In response to the alarm being actionable, the program code causes the apparatus to generate an actionable event, and determine if a first entitlement is triggered by the actionable event. In response to the first entitlement being triggered, the program code causes the apparatus to implement a first entitlement process, and in response to the first entitlement not being triggered, determine if a second entitlement is triggered by the actionable event.

In an aspect of the invention, the first entitlement may be vendor warranty coverage, and the second entitlement may be a contract coverage.

In another aspect of the invention, the program code may cause the apparatus to determine if the second entitlement is triggered by the actionable event by, in response to the first entitlement not being triggered by the actionable event, determining if a contract is associated with the actionable event, and if the contract is associated with the actionable event, determining if the contract coverage applies to the actionable event.

In another aspect of the invention, the actionable event may identify a customer, and the program code may cause the apparatus to determine if the contract coverage applies to the actionable event by determining if the customer is on the contract. If the customer is on the contract, the program code may cause the apparatus to determine that the contract coverage applies to the actionable event, and if the customer is not on the contract, the program code may cause the apparatus to determine that the contract coverage does not apply to the actionable event.

In another aspect of the invention, the actionable event may identify an asset and a component of the asset, and the program code may cause the apparatus to determine if the first entitlement is triggered by the actionable event by determining if the component is under a component warranty. If the component is not under the component warranty, the program code may cause the apparatus to determine if the asset is under an asset warranty. If either the component is under the component warranty or the asset is under the asset warranty, the program code may cause the apparatus to determine the first entitlement is triggered by the actionable event. If neither the component is under the component warranty nor the asset is under the asset warranty, the program code may cause the apparatus to determine the first entitlement is not triggered by the actionable event.

In another aspect of the invention, the alarm may identify an asset, and the program code may cause the apparatus to determine if the alarm is actionable by determining an identity of at least one of the asset, a component of the asset, and a customer associated with the asset, querying a database for entitlements associated with the asset, the component, or the customer, and only determining the alarm is actionable if the database query returns at least one entitlement.

In another aspect of the invention, the alarm may identify an asset having a component, and the program code may further cause the apparatus to, in response to the component of the asset being associated with a component entitlement, initiate a warranty claim process under terms of the component entitlement. If the asset is not associated with the component entitlement, the program code may cause the apparatus to determine if the asset is associated with an asset entitlement. In response to the asset being associated with the asset entitlement, the program code may cause the apparatus to initiate the warranty claim process under the terms of the asset entitlement. If the asset not associated with the asset entitlement, the program code may cause the apparatus to determine if a customer is associated with a contract entitlement. In response to the customer being associated with the contract entitlement, the program code may cause the apparatus to initiate the warranty claim process under the terms of the contract entitlement.

In another embodiment of the invention, a method is provided. The method includes receiving the alarm from the IoT device and determining if the alarm is actionable. In response to the alarm being actionable, the method generates the actionable event, and determines if the first entitlement is triggered by the actionable event. In response to the first entitlement being triggered, the method implements the first entitlement process, and in response to the first entitlement not being triggered, the method determines if the second entitlement is triggered by the actionable event.

In an aspect of the invention, determining if the second entitlement is triggered by the actionable event may include, in response to the first entitlement not being triggered by the actionable event, determining if the contract is associated with the actionable event, and if the contract is associated with the actionable event, determining if the contract coverage applies to the actionable event.

In another aspect of the invention, the actionable event may identify the customer, and determining if the contract coverage applies to the actionable event may include determining if the customer is on the contract, if the customer is on the contract, determining that the contract coverage applies to the actionable event, and if the customer is not on the contract, determining that the contract coverage does not apply to the actionable event.

In another aspect of the invention, the actionable event may identify the asset and the component of the asset, and determining if the first entitlement is triggered by the actionable event may include determining if the component is under the component warranty. If the component is not under the component warranty, the method may determine if the asset is under the asset warranty. If either the component is under either the component warranty or the asset is under the asset warranty, the method may determine the first entitlement is triggered by the actionable event. If neither the component is under the component warranty nor the asset is under the asset warranty, the method may determine the first entitlement is not triggered by the actionable event.

In another aspect of the invention, the method may include, in response to the component being under the component warranty, applying the component warranty, and in response to the asset being under the asset warranty, applying the asset warranty.

In another aspect of the invention, the alarm may identify the asset. Determining if the alarm is actionable may then include determining the identity of at least one of the asset, a component of the asset, and the customer associated with the asset, querying a database for entitlements associated with the asset, the component, or the customer, and only determining the alarm is actionable if the database query returns at least one entitlement.

In another aspect of the invention, the alarm may identify the asset, and generating the actionable event may include creating a data object, determining an identity of at least one of the asset, a component of the asset, and a customer associated with the asset, and storing the identity of the at least one of the asset, the component of the asset, and the customer associated with the asset in the data object.

In another aspect of the invention, the alarm may identify the asset as having a component, and the method may further include, in response to the component of the asset being associated with a component entitlement, initiating a warranty claim process under terms of the component entitlement.

In another aspect of the invention, the method may include, in response to the component of the asset not being associated with the component entitlement, determining if the asset is associated with an asset entitlement, and in response to the asset being associated with the asset entitlement, initiating the warranty claim process under the terms of the asset entitlement.

In another aspect of the invention, in response to the asset not being associated with the asset entitlement, the method may determine if a customer is associated with a contract entitlement, and in response to the customer being associated with the contract entitlement, initiate the warranty claim process under the terms of the contract entitlement.

In another aspect of the invention, in response to the customer not being associated with the contract entitlement, the method may apply default entitlements.

In another embodiment of the invention, a computer program product is provided. The computer program product includes a non-transitory computer-readable storage medium, and program code stored on the non-transitory computer-readable storage medium. The program code is configured so that, when executed by one or more processors, the program code causes the one or more processors to receive the alarm from an IoT device and determine if the alarm is actionable. In response to the alarm being actionable, the program code causes the one or more processors generate the actionable event and determine if the first entitlement is triggered by the actionable event. In response to the first entitlement being triggered, the program code causes the one or more processors to implement the first entitlement process, and in response to the first entitlement not being triggered, determine if the second entitlement is triggered by the actionable event.

The above summary presents a simplified overview of some embodiments of the invention to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an operating environment including an IoT platform in accordance with an exemplary embodiment of the invention.

FIG. 2 is a flowchart of a main process for providing alarm response automation that may be executed by the IoT platform of FIG. 1.

FIGS. 3-7 are flowcharts of processes that may be executed as part of the main process of FIG. 2.

FIGS. 8-10 are diagrammatic views illustrating benefits that may be provided to manufacturers, distributers, and customers by the IoT platform of FIG. 1.

FIG. 11 is a diagrammatic view of a computer that may be used to implement one or more of the components or processes shown in FIGS. 1-7.

It should be understood that the appended drawings are not necessarily to scale, and may present a somewhat simplified representation of various features illustrative of the basic principles of the invention. The specific design features of the sequence of operations disclosed herein, including, for example, specific dimensions, orientations, locations, and shapes of various illustrated components, may be determined in part by the particular intended application and use environment.

### DETAILED DESCRIPTION

Embodiments of the invention filter asset-affiliated data received from sensors associated with the Internet of Things (IoT). The filtered data may then be provided to an actionable IoT platform that determines when an action needs to occur. The IoT platform may further create exceptions that are available to determine hierarchical entitlements.

The IoT platform solves shortcomings in the prior art by integrating a service supply chain with a pre-emptive service specifically designed to function at the actionable IoT data level. Embodiments of the invention thereby pave the way for new, revenue-generating service offerings. Alarm response automation may help companies leverage their intelligent services initiatives. New models, as well as asset, service level entitlements, and workflow building blocks provided by embodiments of the invention may assist organizations in analyzing IoT data and expediting the execution of outcome-based service strategies.

Asset entitlements including service level agreements affiliated with vendor warranties, customer warranties, and customer contracts can provide significant value when applied properly. Embodiments of the invention may be combined with platform building blocks that sit below the IoT solution platform and IoT data, and above transactional systems such as enterprise resource planning (ERP), field service management (FSM), contact center, and any other business systems, and provide a path for organizations to provide pre-emptive maintenance.

The pathways provided may enable a more outcome-based contract model that moves away from traditional preventative maintenance and capitalizes on IoT alarms. In essence, embodiments of the invention move away from what is “scheduled” to what is actually “used”. In the end, this may help organizations provide definable and automated intelligent filtration of data to minimize IoT “noise” so that IoT data can be used more effectively. Actionable events may be managed via workflow, asset insights, service level agreements, warranty recovery, service contracts, Engineering Change Notices (ECNs), and operational analytics. This may close the data loop, thereby enabling realization of Artificial Intelligence (AI), machine learning, and Robotic Process Automation (RPA) vision. Realizing additional value out of IoT implementation may be one benefit. This may entail parsing the problem, minimizing data feeds, and acting on those problems that cause organizations to expend the most resources.

One aspect of the invention may be an interlacing of data, methods, and technologies specifically designed to culminate into one single view. This view may be further defined by an enhanced workflow engine. Advantageously, this may result in intelligent, automated actions (human or systemic interventions) that provide better filtering and management of actionable IoT alarms as compared to IoT systems lacking these features.

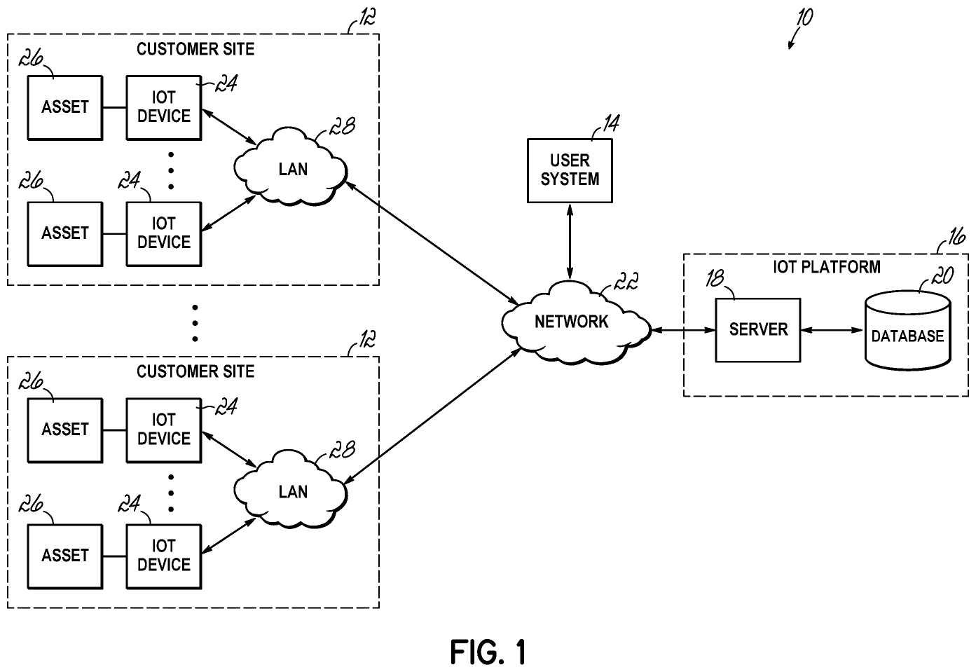

FIG. 1 depicts an exemplary operating environment 10 in accordance with an embodiment of the invention. The operating environment 10 may include one or more customer sites 12, a user system 14, an IoT platform 16 including a server 18 and a database 20, and a network 22. Each customer site 12 may include one or more IoT devices 24 each associated with one or more assets 26 and in communication with the network 22 via a Local Access Network (LAN) 28 or other suitable communication gateway. The IoT devices 24 may include, or receive data from, sensors or other circuits that monitor the assets 26.

The server 18 may comprise a computer system or cloud-based service that includes at least one running instance of an application which provides functionality for other applications or “clients”. Client applications may be hosted, for example, by one or more of the user system 14 or IoT devices 24. Exemplary services that may be provided by the server 18 include an application server, a file server, a web server, a database server (e.g., that manages database 20), or any other suitable server. The IoT devices 24 may collect and transmit data to the server 18. The server 18 may then process and store the data in the database 20. The data in the database 20 may be accessed by any authorized computer system, such as the user system 14, e.g., using a web-browser or other client application.

To access data in the database 20, a user may be required to provide authentication information (e.g., user ID and password) to the server 18. Based on the identity of the user, the server 18 may control which data the user is allowed to access. This may allow data received from a plurality of customer sites 12 and IoT devices 24 each having a different set of authorized users to be accessible to just those users, and to only provide data which the user requesting access is authorized to see. By way of example, the server 18 may be configured to provide a user with data specific to specific customer sites 12 or IoT devices 24, e.g., only IoT devices 24 associated with an appliance manufactured by the user.

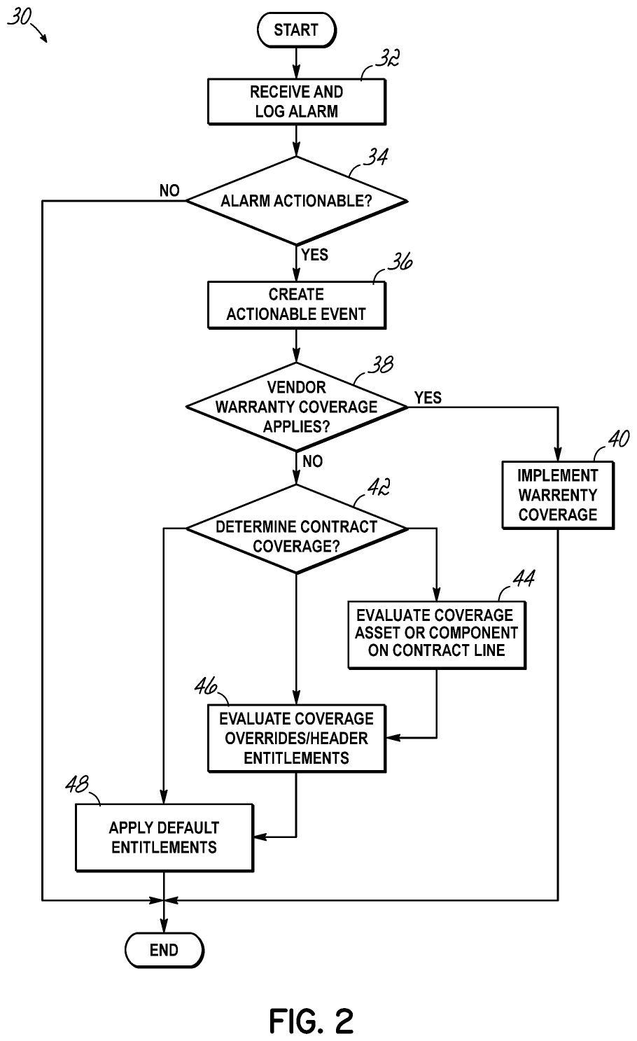

FIG. 2 depicts a flowchart illustrating an entitlement determination process 30 that may be implemented by IoT platform 16 or any other suitable computer of operating environment 10. The process 30 may be considered a “main” or “parent” that performs an actionable event entitlement determination according to one or more aspects of the invention. Entitlements may be defined, for example, by warranties or contracts, and may apply to an asset or a component of the asset. The process 30 may illustrate an exemplary embodiment of a hierarchical application of asset entitlements to IoT-generated actionable events affiliated with alarm response automation. For example, the process 30 may be configured to determine if an alarm received from an IoT device 24 triggers application of an asset entitlement, and if so, what that entitlement should be.

In block 32, the process 30 may receive and log an alarm from one of the IoT devices 24. The alarm may be indicative of, for example, a failure or some other issue impacting operation of the asset 26. In response to receiving the alarm, the process 30 may proceed to block 34 and determine if the alarm is actionable. The alarm may be actionable, for example, if it requires immediate attention. Immediate attention may be required if the alarm is due to the failure of a critical appliance (e.g., a residential heating system in winter) or some other time-sensitive issue. If the alarm is not actionable (“NO” branch of decision block 34), the process 30 may terminate. If the alarm is actionable (“YES” branch of decision block 34), the process 30 may proceed to block 36.

In block 36, the process 30 may generate an actionable event. The actionable event may comprise a data object (e.g., a database record) that manages information relating to further processing of the alarm. The process 30 may then proceed to block 38 and determine if vendor warranty coverage applies to the actionable event. If vendor warranty coverage does apply (“YES” branch of decision block 38), the process 30 may proceed to block 40, implement a warranty coverage process, and terminate. If vendor warranty coverage does not apply (“NO” Branch of decision block 38), the process 30 may proceed to block 42 and determine if there is contract coverage.

A contract may include a header and one or more lines. The header may include a brief description of what is covered, and specify a duration of the contract. The header may also include one or more fields that define the customer, pricing, billing, renewal rules, administrative rules, or any other rules that apply to the contract as a whole. Values from the header of the contract may be defaulted to the lines. Each line may define an individual service that is included in the contract, and a single contract may have multiple lines. Lines may specify what the service covers, counters where usage is tracked, or any other aspect of the service defined by the line.

Each line may inherit certain information from the contract header, such as effectivity dates, bill to and ship to information, and billing rules and schedules. The contract may include different types of lines, such as service lines and usage lines. Service lines may cover a broad categories of items such as field service, repair, call center, technical support, or any other business activities for one or more assets. Usage lines may define charges for usage of a service provided by the line. For example, an office supply vendor may charge the customer based on the number of copies that are made within a predefined period of time.

How the process proceeds from block 42 may depend on the results of the contract analysis. For example, if the asset 26 or component that triggered the IoT alarm is on a contract line, the process 30 may proceed to block 44 and evaluate coverage options for that scenario. Other operational scenarios may include the process 30 proceeding to block 46 and evaluating coverage overrides or header entitlements, and proceeding to block 48 and applying default entitlements.

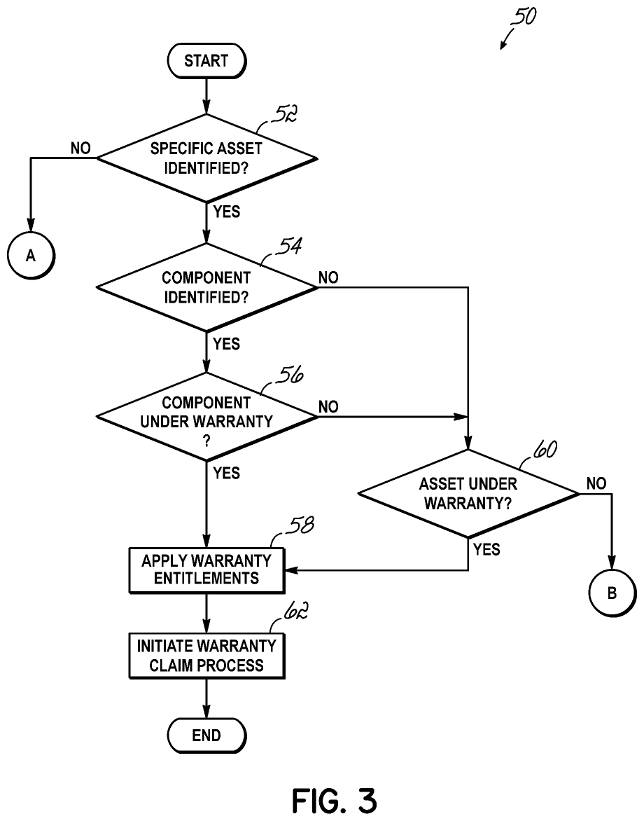

The process 30 may include various levels within the hierarchy that work in concert with one another. FIGS. 3-7 depict flowcharts illustrating various processes that may be executed within a parent process in accordance with embodiments of the invention, and provide additional details of how the functions of the parent process may be implemented in various embodiments of the invention.

FIG. 3 depicts a flowchart illustrating a process 50 that may be used for determining if the actionable event triggers vendor warranty coverage. An IoT alarm generated by an asset 26 may thereby give rise to an actionable event that causes the IoT platform 16 to evaluate the asset 26 for vendor warranty coverage. If vendor warranty coverage applies, the process 50 may auto-apply entitlements using a service provider, if applicable. If the component or asset is under warranty, the invention may initiate a warranty claim process.

In block 52, the process 50 may determine if the IoT alarm identifies a specific asset 26. The IoT alarm may include data indicative of an identity of the asset 26 to which the IoT device 24 is attached, and data indicative of the cause of the alarm, such an error code generated by a processor of the asset 26. Exemplary data that may be used to identify the asset 26 may include one or more of a Universal Product Code (UPC), European Article Number (EAN), Japanese Article Number (JAN), International Standard Book Number (ISBN), Manufacturer Part Number (MPN), a serial number of the asset 26, or any other suitable data.

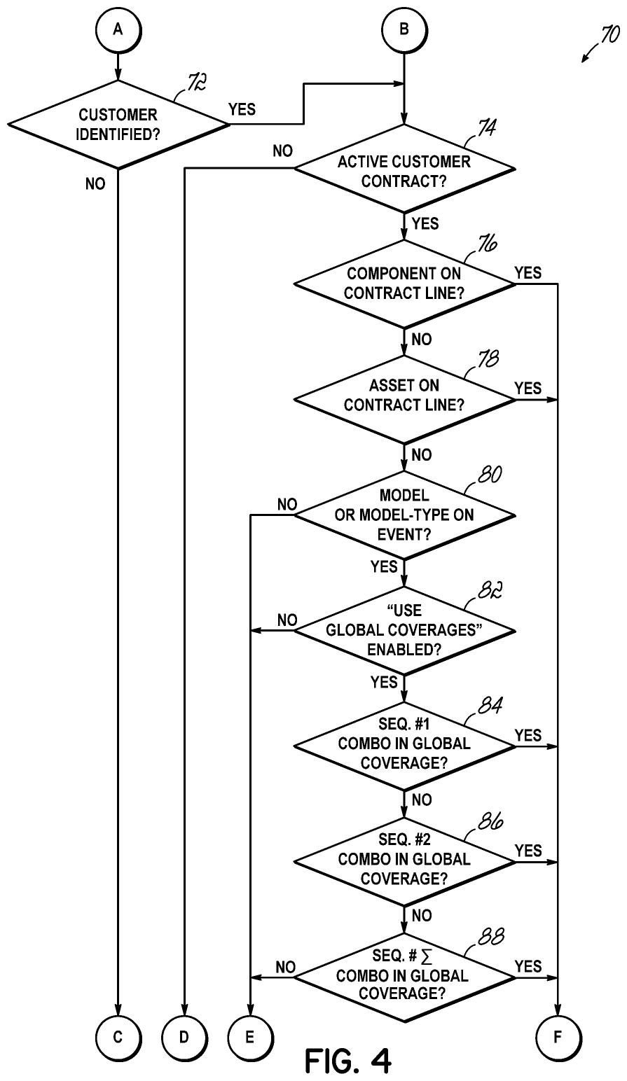

If the IoT alarm does not identify a specific asset 26 (“NO” branch of decision block 52), the parent process may exit process 50, and proceed to block 72 of process 70 (FIG. 4). If the IoT alarm identifies a specific asset 26 (“YES” branch of decision block 52), the process 50 may proceed to block 54 and determine if the IoT alarm identifies a component of the asset 26. A component of the asset 26 may be, for example, a motor, circuit board, power source, or other part that has failed, thereby triggering the IoT alarm. The component may be directly identified by data in the IoT alarm, or by using data in the IoT alarm (e.g., the asset identification and error code) to look up the component in the database 20.

If the component is identified (“YES” branch of decision block 54), the process 50 may proceed to block 56 and determine if the component is under warranty. If the component is under warranty (“YES” branch of decision block 56), the process 50 may proceed to block 58. If the component is not identified (“NO” branch of decision block 54), or the component is not under warranty (“NO” branch of decision block 56), the process 50 may proceed to block 60 and determine if the asset 26 is under warranty. If the asset 26 is not under warranty, (“NO” branch of decision block 60), the parent process may exit process 50, and proceed to block 74 of process 70 (FIG. 4). If the asset 26 is under warranty, (“YES” branch of decision block 60), the process 50 may proceed to block 58.

In block 58, the process 50 may apply the warranty entitlements, proceed to block 62, and initiate a warranty claim process in accordance with the applied warranty. Initiating the warranty claim process may include, for example, generating and submitting a claim to the manufacturer or workorder to repair or replace the component or asset 26 based on the terms of the applicable warranty as determined in blocks 56-60.

The process 50 may determine whether the component or asset 26 is under warranty by querying the database 20 for information regarding what entitlements apply to the component or asset, as the case may be. These may include one or more manufacturer warranties, distributer warranties, contracts (e.g., an “extended warranty” purchased from the seller), or any other entitlement. If more than one entitlement is applicable under the sales agreement, the process 50 may select the entitlement to enforce in a hierarchical manner. Although the exemplary process 50 is depicted as giving priority to component entitlements over asset entitlements, it should be understood that embodiments of the invention are not limited to a particular hierarchical order. Accordingly, other hierarchical orders may be implemented, e.g., by prioritizing enforcement of asset entitlements over component entitlements. The hierarchical order in which entitlements are applied may be structured to minimize the cost to one or more of the customer, seller, distributer, supplier, or manufacturer, and may vary depending on the asset in question.

FIG. 4 depicts a flowchart illustrating a process 70 that may be used to determine if the actionable event triggers contract coverage in cases where neither component nor asset warranty coverage applies. The process 70 may determine contract coverage based on customer coverage and global coverage. If there are no assets or components listed on the customer contract, but there is a model or model-type listed, the process 70 may auto-apply entitlements based on an active customer status. For example, in the absence of an active warranty on either the component or the asset 26, a contract may be in force that provides coverage to the specific customer (e.g., due to asset insurance purchased by the customer) or global coverage of the asset 26. By way of example, global coverage may be triggered if there is a recall in effect for the make or model of the asset 26 for an issue identified by the IoT alarm, such as a failure due to a known manufacturer defect.

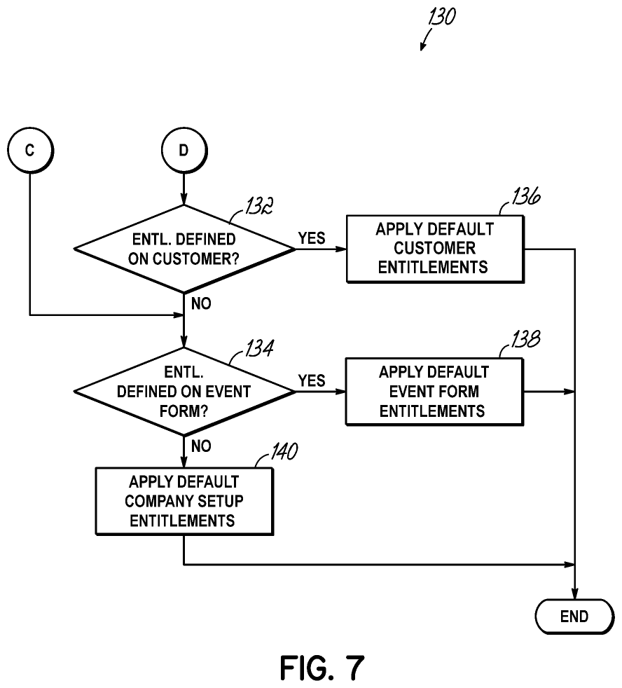

In block 72, the process 70 may determine if the customer is identified by the actionable event. The customer may be identified based on customer identification data in the IoT alarm (e.g., if the IoT device 24 or asset 26 has been provided with the customer identity during setup), or by querying the database 20 for information on who purchased the asset 26. If the customer is not identified (“NO” branch of decision block 72), the parent process may exit process 70, and proceed to block 134 of process 130 (FIG. 7).

If the customer is identified (“YES” branch of decision block 72), the process 70 may proceed to block 74 and determine if there is an active customer contract (e.g., a service agreement or extended warranty) that applies to the asset 26. This determination may be made, for example, by querying the database 20 for contracts associated with the customer, and then looking for associations between the contract and the asset 26 in the database 20 or defined in the header or lines of the contract.

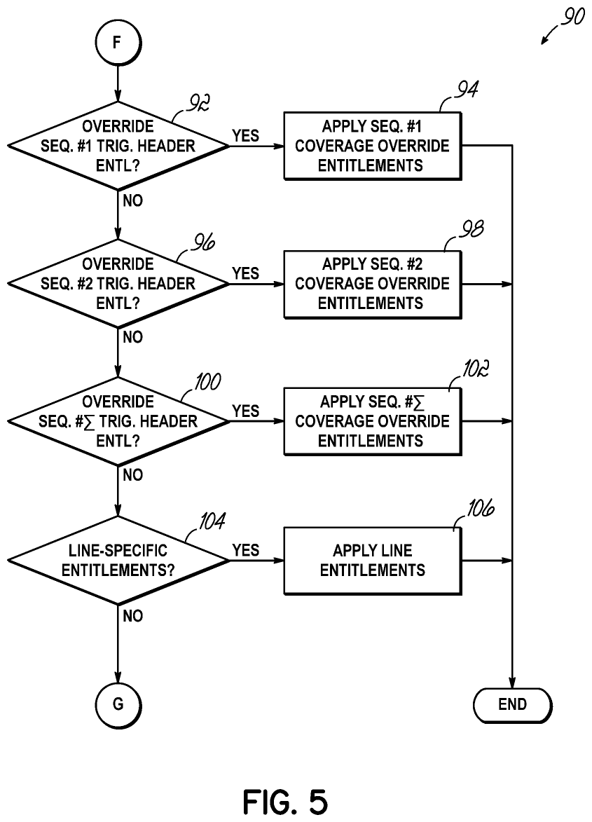

If no active customer contracts apply to the customer or asset (“NO” branch of decision block 74), the parent process may exit process 70, and proceed to block 132 of process 130 (FIG. 7). If an active customer contract does apply (“YES” branch of decision block 74), the process 70 may proceed to block 76 and determine if the component identified by the IoT alarm is listed on a line of the contract. If the component is listed on a line of the contract (“YES” branch of decision block 76), the parent process may exit process 70 and proceed to block 92 of process 90 (FIG. 5). If the component is unknown or not listed on a line of the contract (“NO” branch of decision block 76), the process 70 may proceed to block 78.

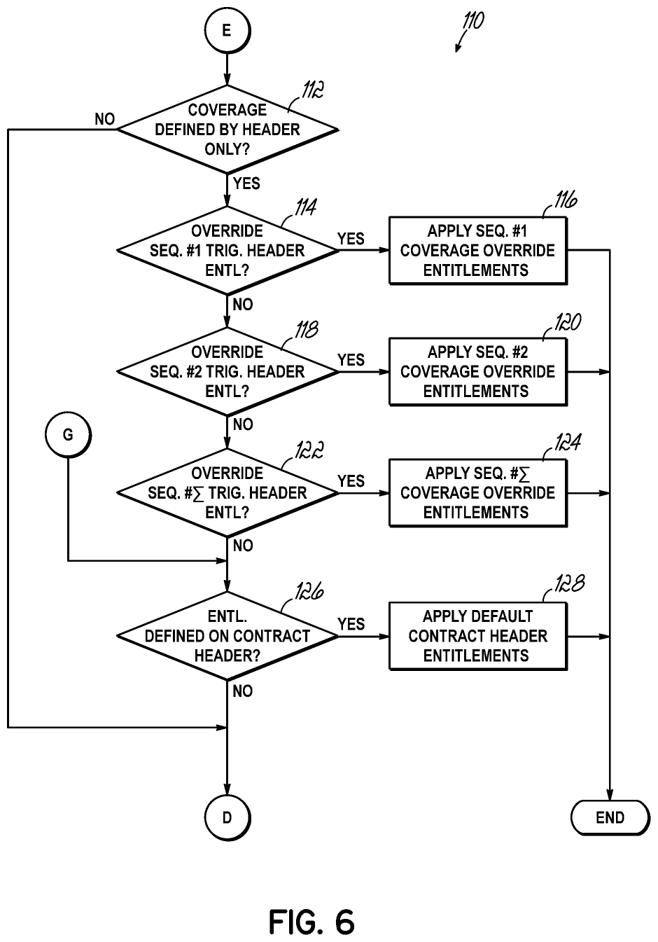

In block 78, the process 70 may determine if the asset 26 identified by the IoT alarm is listed on the contract line that identifies covered items. If the asset 26 is listed on the contract line (“YES” branch of decision block 78), the parent process may exit process 70 and proceed to block 92 of process 90. If the asset 26 is not listed on the contract line (“NO” branch of decision block 78), the process 70 may proceed to block 80 and determine if a model or model-type of the asset 26 is identified in the actionable event. If the model or model-type of asset 26 is not identified (“NO” branch of decision block 80), the parent process may exit process 70 and proceed to block 112 of process 110 (FIG. 6). If the model or model-type of asset 26 is identified (“YES” branch of decision block 80), the process 70 may proceed to block 82 and determine if a “use global coverages” feature is enabled.

If global coverages are not enabled (“NO” branch of decision block 82), the parent process may exit process 70 and proceed to block 112 of process 110 (FIG. 6). If the global coverages are enabled (“YES” branch of decision block 82), the process 70 may proceed to block 84. In block 84, the process 70 may determine if a predetermined combination of model or model type and event type (e.g., “sequence #1 combination”) is enabled under global coverage. If the predetermined combination of model or model type and event is enabled under global coverage (“YES” branch of decision block 84), the parent process may exit process 70 and proceed to block 92 of process 90. If the predetermined combination of model or model type and event is not satisfied (“NO” branch of decision block 84), the process 70 may proceed to block 86 and determine if the next combination of model or model type and event in the sequence of combinations (e.g., sequence #2 combination) is enabled under global coverage.

As depicted by block 88, there may be any number of predefined combinations of model or model type and event that are sequentially evaluated by process 70. For each combination in the sequence of combinations, if the combination is satisfied, the parent process may exit process 70 and proceed to block 92 of process 90. If none of the predefined combinations are satisfied, the parent process may exit process 70 and proceed to block 112 of process 110.

FIG. 5 depicts a flowchart illustrating a process 90 that may determine if an entitlement is overridden by defined coverage overrides. Process 90 may evaluate coverage overrides and asset attributes if an asset or component appears on a contract line. Contract coverage overrides may override and automatically apply rules when all criteria defined in the specific override is present in the actionable event. In this case, a combination of model type, event type, and urgency must be met. This process may occur after the asset 26 generates an IoT alarm which then generates an actionable event.

In block 92, the process 90 may determine if a predetermined combination of model or model type, event type, and urgency level (e.g., the “sequence #1 combination”) is satisfied by the actionable event. If the predetermined combination of model or model type, event type, and urgency level is satisfied (“YES” branch of decision block 92), the process 90 may proceed to block 94, apply the sequence #1 coverage override entitlements, and terminate. If the predetermined combination of model or model type, event type, and urgency level is not satisfied (“NO” branch of decision block 92), the process 90 may proceed to block 96 and determine if the next combination of model or model type, event, and urgency level in the sequence of combinations (e.g., sequence #2 combination) is satisfied. If the predetermined combination of model or model type, event type, and urgency level is satisfied (“YES” branch of decision block 96), the process 90 may proceed to block 98, apply the sequence #2 coverage override entitlements, and terminate.

As depicted by block 100, there may be any number of predefined combinations of model or model type, event, and urgency level that are sequentially evaluated by process 90. For each combination in the sequence of combinations, if the combination is satisfied, the process 90 may proceed to block 102, apply the corresponding sequence #1 of coverage override entitlements, and terminate. If none of the predefined combinations are satisfied, the process 90 may proceed to block 104.

In block 104, the process 90 may determine if any line-specific entitlements defined by the contract are triggered. If any line specific entitlements are triggered (“YES” branch of decision block 104), the process 90 may proceed to block 106, apply the triggered line entitlements, and terminate. If no line-specific entitlements of the contract are triggered (“NO” branch of decision block 104), the parent process may exit process 90 and proceed to block 126 of process 110.

FIG. 6 depicts a flowchart illustrating a process 110 that may determine if an entitlement is provided by the header of the contract in cases where line coverage is absent, or the contract lines are overridden by defined coverage overrides. Process 110 may provide a header-driven contract evaluation of coverage overrides or header entitlements. To this end, process 110 may evaluate the asset 26 for service contract entitlements at the contract header level and auto-apply contract header entitlements based on the customer, if applicable. This may occur after the asset generates an IoT alarm that generates an actionable event which is then analyzed by the parent process.

In block 112, the process 110 may determine if the contract setting is to determine coverage by searching only the contract header. If the contract coverage is not limited to only what is provided in the header (“NO” branch of decision block 112), the parent process may exit process 110 and proceed to block 132 of process 130 (FIG. 7). If the contract coverage is limited to only what is provided in the header (“YES” branch of decision block 112), the process 110 may proceed to block 114.

In block 114, the process 110 may determine if a predetermined combination of model or model type, event type, and urgency level (e.g., “sequence #1 combination) is satisfied by the actionable event. If the predetermined combination of model or model type, event type, and urgency level is satisfied (“YES” branch of decision block 114), the process 110 may proceed to block 116, apply the sequence #1 coverage override entitlements, and terminate. If the predetermined combination of model or model type, event type, and urgency level is not satisfied (“NO” branch of decision block 114), the process 110 may proceed to block 118 and determine if the next combination of model or model type, event, and urgency level in the sequence of combinations (e.g., sequence #2 combination) is satisfied. If the predetermined combination of model or model type, event type, and urgency level is satisfied (“YES” branch of decision block 118), the process 110 may proceed to block 120, apply the sequence #2 coverage override entitlements, and terminate.

As depicted by block 122, there may be any number of predefined combinations of model or model type, event, and urgency level that are sequentially evaluated by process 110. For each combination in the sequence of combinations, if the combination is satisfied, the process 110 may proceed to block 124, apply the corresponding sequence #1 of coverage override entitlements, and terminate. If none of the predefined combinations are satisfied, the process 110 may proceed to block 126.

In block 126, the process 110 may determine if any entitlements defined by the header of the contract are triggered. If any of these entitlements are triggered (“YES” branch of decision block 126), the process 110 may proceed to block 128, apply the default contract header entitlement, and terminate. If no entitlements defined by the header of the contract are triggered (“NO” branch of decision block 126), the process 110 may proceed to block 132 of process 130.

FIG. 7 depicts a flowchart illustrating a process 130 that may determine what default entitlements apply to the IoT alarm if it fails to trigger any warranty or contract defined entitlements. For example, the process 130 may apply default entitlements if no warranty or contract coverages are found that apply. These default entitlements may provide a safety net if no warranty or contract terms are affiliated with the asset data supplied in the actionable event.

In block 132, the process 130 may determine if any default customer entitlements are triggered. If no default customer entitlements are triggered (“NO” branch of decision block 132), the process 130 may proceed to block 134. If any default customer entitlements are triggered (“YES” branch of decision block 132), the process 130 may proceed to block 136 and apply the default customer entitlements.

In block 134, the process 130 may determine if any entitlements defined by the event form are triggered. If any entitlements defined by the event form are triggered (“YES” branch of decision block 134), the process 130 may proceed to block 138 and apply the default event form entitlements. If no entitlements defined by the event form are triggered (“NO” branch of decision block 134), the process 130 may proceed to block 140 and apply any company setup entitlements. In each case, once the process 130 has applied the respective default entitlements, the process 130 may terminate.

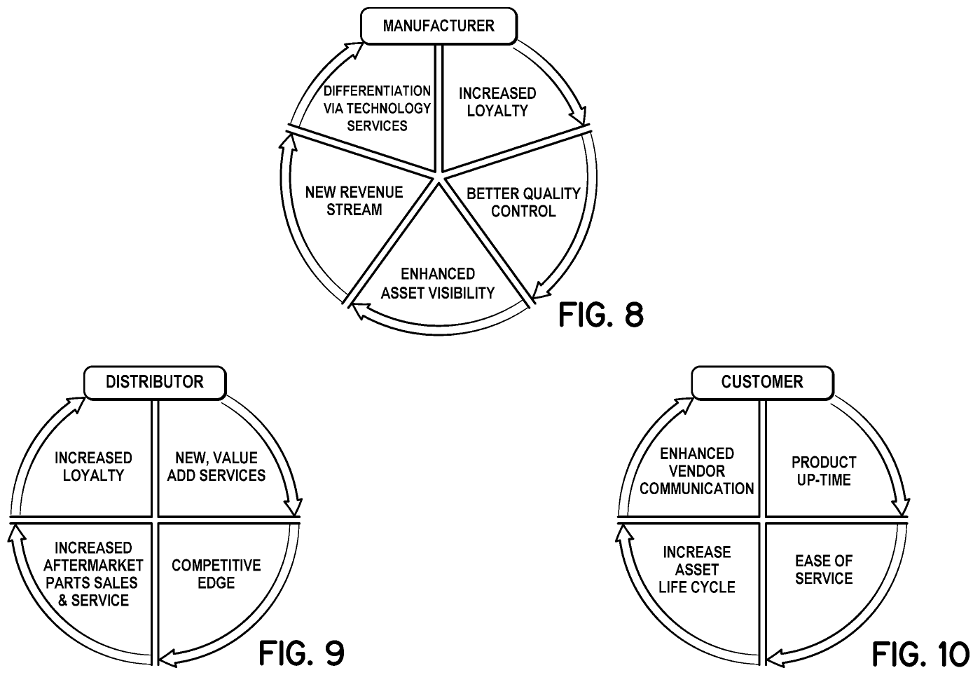

FIGS. 8-10 are schematic diagrams showing manufacturer, distributor, and customer benefits that may be provided by embodiments of the invention. Manufacturer benefits may include, but are not limited to, increased loyalty, better quality control, enhanced asset visibility, new revenue streams, and differentiation via technology services. Distributor benefits may include, but are not limited to, new value add services, increased competitive edge, increased aftermarket parts sales and service, and increased loyalty. Customer benefits may include, but are not limited to, improved product up-time, ease of service, increased asset life cycle, and enhanced vendor communication.

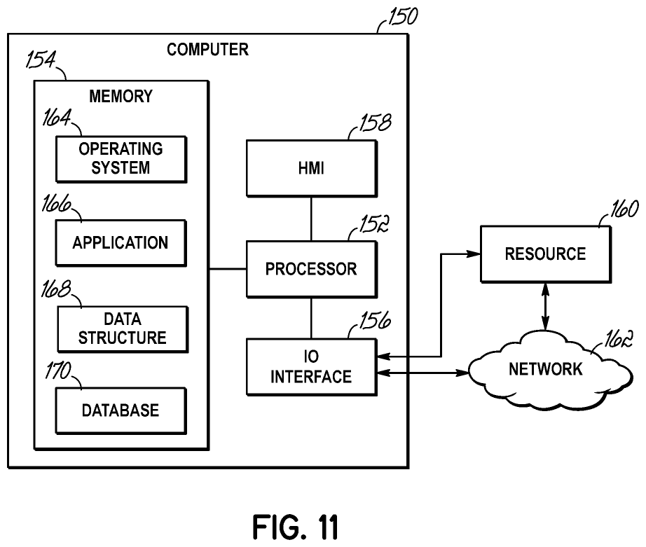

Referring now to FIG. 11, embodiments of the invention described above, or portions thereof, may be implemented using one or more computer devices or systems, such as exemplary computer 150. The computer 150 may include a processor 152, a memory 154, an input/output (I/O) interface 156, and a Human Machine Interface (HMI) 158. The computer 150 may also be operatively coupled to one or more external resources 160 via the network 162 or I/O interface 156. External resources may include, but are not limited to, servers, databases, mass storage devices, peripheral devices, cloud-based network services, or any other resource that may be used by the computer 150.

The processor 152 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions stored in memory 154. Memory 154 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data.

The processor 152 may operate under the control of an operating system 164 that resides in memory 154. The operating system 164 may manage computer resources so that computer program code embodied as one or more computer software applications, such as an application 166 residing in memory 154, may have instructions executed by the processor 152. In an alternative embodiment, the processor 152 may execute the application 166 directly, in which case the operating system 164 may be omitted. One or more data structures 168 may also reside in memory 154, and may be used by the processor 152, operating system 164, or application 166 to store or manipulate data.

The I/O interface 156 may provide a machine interface that operatively couples the processor 152 to other devices and systems, such as the external resource 160 or the network 162. The application 166 may thereby work cooperatively with the external resource 160 or network 162 by communicating via the I/O interface 156 to provide the various features, functions, applications, processes, or modules comprising embodiments of the invention. The application 166 may also have program code that is executed by one or more external resources 160, or otherwise rely on functions or signals provided by other system or network components external to the computer 150. Indeed, given the nearly endless hardware and software configurations possible, persons having ordinary skill in the art will understand that embodiments of the invention may include applications that are located externally to the computer 150, distributed among multiple computers or other external resources 160, or provided by computing resources (hardware and software) that are provided as a service over the network 162, such as a cloud computing service.

The HMI 158 may be operatively coupled to the processor 152 of computer 150 to allow a user to interact directly with the computer 150. The HMI 158 may include video or alphanumeric displays, a touch screen, a speaker, and any other suitable audio and visual indicators capable of providing data to the user. The HMI 158 may also include input devices and controls such as an alphanumeric keyboard, a pointing device, keypads, pushbuttons, control knobs, microphones, etc., capable of accepting commands or input from the user and transmitting the entered input to the processor 152.

A database 170 may reside in memory 154, and may be used to collect and organize data used by the various systems and modules described herein. The database 170 may include data and supporting data structures that store and organize the data. In particular, the database 170 may be arranged with any database organization or structure including, but not limited to, a relational database, a hierarchical database, a network database, or combinations thereof. A database management system in the form of a computer software application executing as instructions on the processor 152 may be used to access the information or data stored in records of the database 170 in response to a query, which may be dynamically determined and executed by the operating system 164, other applications 166, or one or more modules.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations or elements embodying the various aspects of the embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, or operations specified in the text of the specification, the flowcharts, sequence diagrams, or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, or operations specified in the text of the specification, flowcharts, sequence diagrams, or block diagrams.

The flowcharts and block diagrams depicted in the figures illustrate the architecture, functionality, or operation of possible implementations of systems, methods, or computer program products according to various embodiments of the invention. In this regard, each block in the flowchart or block diagrams may represent a module, segment, or portion of instructions, which comprises one or more executable instructions for implementing the specified logical function or functions.

In certain alternative embodiments, the functions, acts, or operations specified in the text of the specification, the flowcharts, sequence diagrams, or block diagrams may be re-ordered, processed serially, or processed concurrently consistent with embodiments of the invention. Moreover, any of the flowcharts, sequence diagrams, or block diagrams may include more or fewer blocks than those illustrated consistent with embodiments of the invention. It should also be understood that each block of the block diagrams or flowcharts, or any combination of blocks in the block diagrams or flowcharts, may be implemented by a special purpose hardware-based system configured to perform the specified functions or acts, or carried out by a combination of special purpose hardware and computer instructions.

The terminology used herein is for the purpose of describing particular embodiments only and is not intended to be limiting of the embodiments of the invention. As used herein, the singular forms “a”, “an” and “the” are intended to include both the singular and plural forms, and the terms “and” and “or” are each intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the inventors to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

What is claimed is:

1. An apparatus comprising:
one or more processors; and
a memory coupled to the one or more processors and including program code that, when executed by the one or more processors, causes the apparatus to:
receive an alarm from an IoT device;
determine if the alarm is actionable;
in response to the alarm being actionable, generate an actionable event;
determine if a first entitlement is triggered by the actionable event;
in response to the first entitlement being triggered, implement a first entitlement process; and
in response to the first entitlement not being triggered, determine if a second entitlement is triggered by the actionable event.

2. The apparatus of claim 1, wherein the first entitlement is a vendor warranty coverage, and the second entitlement is a contract coverage.

3. The apparatus of claim 2, wherein the program code causes the apparatus to determine if the second entitlement is triggered by the actionable event by:
in response to the first entitlement not being triggered by the actionable event, determining if a contract is associated with the actionable event; and
if the contract is associated with the actionable event, determining if the contract coverage applies to the actionable event.

4. The apparatus of claim 3, wherein the actionable event identifies a customer, and the program code causes the apparatus to determine if the contract coverage applies to the actionable event by:
determining if the customer is on the contract;
if the customer is on the contract, determining that the contract coverage applies to the actionable event; and
if the customer is not on the contract, determining that the contract coverage does not apply to the actionable event.

5. The apparatus of claim 3, wherein the actionable event identifies an asset and a component of the asset, and the program code causes the apparatus to determine if the first entitlement is triggered by the actionable event by:
determining if the component is under a component warranty;
if the component is not under the component warranty, determining if the asset is under an asset warranty;
if either the component is under the component warranty or the asset is under the asset warranty, determining the first entitlement is triggered by the actionable event; and
if neither the component is under the component warranty nor the asset is under the asset warranty, determining the first entitlement is not triggered by the actionable event.

6. The apparatus of claim 1, wherein the alarm identifies an asset, and the program code causes the apparatus to determine if the alarm is actionable by:
determining an identity of at least one of the asset, a component of the asset, and a customer associated with the asset;
querying a database for entitlements associated with the asset, the component, or the customer; and
only determining the alarm is actionable if the database query returns at least one entitlement.

7. The apparatus of claim 1, wherein the alarm identifies an asset having a component, and the program code further causes the apparatus to:
in response to the component of the asset being associated with a component entitlement, initiate a warranty claim process under terms of the component entitlement;
in response to the component of the asset not being associated with the component entitlement, determine if the asset is associated with an asset entitlement;
in response to the asset being associated with the asset entitlement, initiate the warranty claim process under the terms of the asset entitlement;
in response to the asset not being associated with the asset entitlement, determine if a customer is associated with a contract entitlement; and
in response to the customer being associated with the contract entitlement, initiate the warranty claim process under the terms of the contract entitlement.

8. A method comprising:
receiving an alarm from an IoT device;
determining if the alarm is actionable;
in response to the alarm being actionable, generating an actionable event;
determining if a first entitlement is triggered by the actionable event;
in response to the first entitlement being triggered, implementing a first entitlement process; and
in response to the first entitlement not being triggered, determining if a second entitlement is triggered by the actionable event.

9. The method of claim 8, wherein the first entitlement is a vendor warranty coverage, and the second entitlement is a contract coverage.

10. The method of claim 9, wherein determining if the second entitlement is triggered by the actionable event comprises:
in response to the first entitlement not being triggered by the actionable event, determining if a contract is associated with the actionable event; and
if the contract is associated with the actionable event, determining if the contract coverage applies to the actionable event.

11. The method of claim 10, wherein the actionable event identifies a customer, and determining if the contract coverage applies to the actionable event comprises:
determining if the customer is on the contract;
if the customer is on the contract, determining that the contract coverage applies to the actionable event; and
if the customer is not on the contract, determining that the contract coverage does not apply to the actionable event.

12. The method of claim 10, wherein the actionable event identifies an asset and a component of the asset, and determining if the first entitlement is triggered by the actionable event comprises:
determining if the component is under a component warranty;
if the component is not under the component warranty, determining if the asset is under an asset warranty;
if either the component is under the component warranty or the asset is under the asset warranty, determining the first entitlement is triggered by the actionable event; and
if neither the component is under the component warranty nor the asset is under the asset warranty, determining the first entitlement is not triggered by the actionable event.

13. The method of claim 12, further comprising
in response to the component being under the component warranty, applying the component warranty; and
in response to the asset being under the asset warranty, applying the asset warranty.

14. The method of claim 8, wherein the alarm identifies an asset, and determining if the alarm is actionable comprises:
determining an identity of at least one of the asset, a component of the asset, and a customer associated with the asset;
querying a database for entitlements associated with the asset, the component, or the customer; and
only determining the alarm is actionable if the database query returns at least one entitlement.

15. The method of claim 8, wherein the alarm identifies an asset, and generating the actionable event comprises:
creating a data object;
determining an identity of at least one of the asset, a component of the asset, and a customer associated with the asset; and
storing the identity of the at least one of the asset, the component of the asset, and the customer associated with the asset in the data object.

16. The method of claim 8, wherein the alarm identifies an asset having a component, and further comprising:
in response to the component of the asset being associated with a component entitlement, initiating a warranty claim process under terms of the component entitlement.

17. The method of claim 16, further comprising:
in response to the component of the asset not being associated with the component entitlement, determining if the asset is associated with an asset entitlement; and
in response to the asset being associated with the asset entitlement, initiating the warranty claim process under the terms of the asset entitlement.

18. The method of claim 17, further comprising:
in response to the asset not being associated with the asset entitlement, determining if a customer is associated with a contract entitlement; and
in response to the customer being associated with the contract entitlement, initiating the warranty claim process under the terms of the contract entitlement.

19. The method of claim 18, further comprising:
in response to the customer not being associated with the contract entitlement, applying default entitlements.

20. A computer program product comprising:
a non-transitory computer-readable storage medium; and
program code stored on the non-transitory computer-readable storage medium that, when executed by one or more processors, causes the one or more processors to:
receive an alarm from an IoT device;
determine if the alarm is actionable;
in response to the alarm being actionable, generate an actionable event;
determine if a first entitlement is triggered by the actionable event;
in response to the first entitlement being triggered, implement a first entitlement process; and
in response to the first entitlement not being triggered, determine if a second entitlement is triggered by the actionable event.
